(19) United States
(12) Patent Application Publication
(10) Pub. No.: US 2020/0174920 A1
(43) Pub. Date: Jun. 4, 2020

(54) METHOD FOR RANDOMIZING ADDRESS SPACE LAYOUT OF EMBEDDED SYSTEM BASED ON HARDWARE AND APPARATUS FOR THE SAME

(71) Applicant: ELECTRONICS AND TELECOMMUNICATIONS RESEARCH INSTITUTE, Daejeon (KR)

(72) Inventors: Jin-Yong LEE, Daejeon (KR); Dae-Won KIM, Daejeon (KR); Boo-Sun JEON, Daejeon (KR); Bo-Heung CHUNG, Daejeon (KR); Hong-Il JU, Daejeon (KR); Byeong-Cheol CHOI, Daejeon (KR)

(73) Assignee: ELECTRONICS AND TELECOMMUNICATIONS RESEARCH INSTITUTE, Daejeon (KR)

(21) Appl. No.: 16/695,731

(22) Filed: Nov. 26, 2019

(30) Foreign Application Priority Data
Nov. 29, 2018 (KR) 10-2018-0151116

(51) Int. Cl. G06F 12/02; G06F 13/26

(52) U.S. Cl. CPC G06F 12/023; G06F 2212/251; G06F 13/26

(57) ABSTRACT

Disclosed herein are a method and apparatus for randomizing the address space layout of an embedded system based on hardware. The method is configured such that the hardware loader of the embedded system randomly arranges the respective address regions of multiple peripheral devices and memory using a random number each time a program is loaded, such that the respective random start addresses of the multiple peripheral devices and the memory, which are set based on the randomly arranged address regions, are recorded in an address table, and such that program code loaded into the memory is reengineered based on the address table so as to match the randomly arranged address regions.

### CROSS REFERENCE TO RELATED APPLICATION

This application claims the benefit of Korean Patent Application No. 10-2018-0151116, filed Nov. 29, 2018, which is hereby incorporated by reference in its entirety into this application.

### BACKGROUND OF THE INVENTION

### 1. Technical Field

The present invention relates generally to technology for randomizing the address space of an embedded system, and more particularly to technology for improving the security of an embedded system by performing address space layout randomization using a hardware device each time a program is loaded.

### 2. Description of the Related Art

With the rise of the ‘Internet-of-Things’ (IoT), the number of embedded devices is increasing. Embedded devices are implemented at low cost, and target applications are run directly on the hardware (as bare-metal programs). Compared to traditional desktop environments, embedded systems lack security mechanisms due to insufficient resources. Particularly, address space layout randomization, which is commonly used in Operating Systems (OSs), is also difficult to apply in the bare-metal embedded system due to the absence of a Memory Management Unit (MMU).

In a general embedded system, various peripheral devices, including memory, operate by being connected with a central processing unit (CPU) via a bus or a simple address decoder circuit, as shown in FIG. 1. Here, when an application run by the CPU attempts to access any of the peripheral devices or memory, it is necessary to determine the peripheral device or memory to be accessed, to enable the peripheral device or the memory, and to transmit and receive information based on a predefined protocol.

Generally, in order to provide access convenience to a program, a system has a system-level address space 200 and allocates some address regions therein to peripheral devices and memory, as shown in FIG. 2. Accordingly, when a program accesses a specific address region, the peripheral device or memory that is allocated the address region is automatically enabled, and the program may use the peripheral device or the memory by writing or reading data to or from the memory defined in the system address space 200 using a simple memory access command according to the predefined protocol.

Generally, address regions allocated to peripheral devices and memory are fixed in a system address space 200 when an embedded system is implemented, and are not changed when the embedded system is used. Therefore, when an address is input from a CPU, a bus or an address decoder checks the address on the assumption that the address regions are fixed in a hardware manner. Accordingly, the bus or the address decoder determines the peripheral device or memory to which access is attempted by checking the address regions in the system address space 200 using the input address, thereby attempting access to the corresponding peripheral device or memory.

The fixed system address space 200 is advantageous in that it allows convenience when a program is written and run. However, when information about the fixed system address space 200 is exposed through a data sheet or the like, once an attacker gains permissions to read from or write to the memory, the attacker may cause an erroneous operation in a peripheral device or easily steal important data stored in the memory. Particularly, when such a vulnerability is found in an embedded system that serves to control a device directly related to the safety of a user, for example, a system embedded in a vehicle or a device directly attached to a human body, a serious problem may be caused.

### DOCUMENTS OF RELATED ART

(Patent Document 1) Korean Patent Application Publication No. 10-2005-0043299, published on May 11, 2005 and titled “Method and apparatus for handling interrupt using dynamically allocated memory in embedded system”.

### SUMMARY OF THE INVENTION

An object of the present invention is to randomly update the address space layout of a system each time a program is loaded, thereby improving security in an embedded system.

Another object of the present invention is to improve the security of a system by making it difficult for an attacker to guess the location of code or the addresses of main peripheral devices, which are required for an attack on an embedded system.

A further object of the present invention is to change the addresses of peripheral devices each time a program is run, thereby preventing a direct attack on a peripheral device even when an attacker detects the location of memory and finds a vulnerability through which the attacker can write to a certain address region.

Yet another object of the present invention is to improve the security of an embedded system, which lacks security mechanisms, by merely updating a bus/address decoder, rather than changing a CPU, which is difficult to implement and change in the system.

In order to accomplish the above objects, a method for randomizing the address space layout of an embedded system according to the present invention may include randomly arranging, by the hardware loader of the embedded system, the respective address regions of multiple peripheral devices and memory based on a random number each time a program is loaded; recording, by the hardware loader, the respective random start addresses of the multiple peripheral devices and the memory, which are set based on the randomly arranged address regions, in an address table; and reengineering, by the hardware loader, program code loaded into the memory using the address table so as to match the randomly arranged address regions.

Here, randomly arranging the respective address regions may be configured to randomly update the address regions based on a newly generated random number when execution of a current program is terminated and another program is loaded, and the address table may be updated so as to match the randomly updated address regions.

Here, reengineering the program code may be configured such that, when the program code is access code for accessing any one target peripheral device, among the multiple peripheral devices, the start address of the target peripheral device included in the access code is changed to the random start address of the target peripheral device recorded in the address table.

Here, the method may further include mapping, by the hardware loader, an Interrupt Service Routine (ISR) region based on the memory to the location on the address table in which a start address of the read-only memory of the embedded system is recorded; and causing, by the hardware loader, an interrupt and thereby calling an ISR for jumping to the start location of the program code loaded into the memory when reengineering of the program code is completed.

Here, permissions to access the ISR region may be granted only to the hardware loader.

Here, randomly arranging the respective address regions may be configured to randomly arrange the address regions with reference to hardware information stored in the read-only memory of the embedded system, and the hardware information may include the number of the multiple peripheral devices and the memory and the sizes of the respective address regions of the multiple peripheral devices and the memory.

Here, the program code may be position-independent code, and the access code may be unified so as to have a single pattern.

Here, when the access code is input based on execution of a program after reengineering of the program code is completed, the address decoder of the embedded system may access the target peripheral device with reference to the random start address included in the access code.

Also, an apparatus for randomizing an address space layout according to an embodiment of the present invention may include a hardware-loading unit for randomly arranging the respective address regions of multiple peripheral devices and memory based on a random number each time a program is loaded in an embedded system, recording the respective random start addresses of the multiple peripheral devices and the memory, which are set based on the randomly arranged address regions, in an address table, and reengineering program code loaded into the memory using the address table so as to match the randomly arranged address regions; and a random number generation unit for generating the random number each time the program is loaded.

Here, when execution of a current program is terminated and another program is loaded, the hardware-loading unit may randomly update the address regions based on a newly generated random number and update the address table so as to match the randomly updated address regions.

Here, when the program code is access code for accessing any one target peripheral device, among the multiple peripheral devices, the hardware-loading unit may change the start address of the target peripheral device included in the access code to the random start address of the target peripheral device recorded in the address table.

Here, the hardware-loading unit may map an Interrupt Service Routine (ISR) region based on the memory to the location on the address table in which a start address of the read-only memory of the embedded system is recorded, and may cause an interrupt so as to call an ISR for jumping to the start location of the program code loaded into the memory when reengineering of the program code is completed.

Here, permissions to access the ISR region may be granted only to the hardware-loading unit.

Here, the hardware-loading unit may randomly arrange the address regions with reference to hardware information stored in the read-only memory of the embedded system, and the hardware information may include the number of the multiple peripheral devices and the memory and the sizes of the respective address regions of the multiple peripheral devices and the memory.

Here, the program code may be position-independent code, and the access code may be unified so as to have a single pattern.

Here, when the access code is input based on execution of a program after reengineering of the program code is completed, the address decoder of the embedded system may access the target peripheral device with reference to the random start address included in the access code.

### BRIEF DESCRIPTION OF THE DRAWINGS

The above and other objects, features and advantages of the present invention will be more clearly understood from the following detailed description taken in conjunction with the accompanying drawings, in which:

FIG. 1 and FIG. 2 are views that show an example of an existing embedded system and a system address space;

FIG. 3 is a view that shows an embedded system according to an embodiment of the present invention;

FIG. 4 is a flowchart that shows a method for randomizing the address space layout of an embedded system according to an embodiment of the present invention;

FIG. 5 is a view that shows an example of an address table according to the present invention;

FIG. 6 is a view that shows an example of a system address space according to the present invention;

FIG. 7 is a view that shows an example of the process of unifying an access code pattern according to the present invention;

FIG. 8 is a view that shows an example of an updated command in memory as the result of execution of a hardware loader according to the present invention;

FIG. 9 is a flowchart that specifically shows a method for randomizing the address space layout of an embedded system according to an embodiment of the present invention; and

FIG. 10 is a block diagram that shows an apparatus for randomizing an address space layout according to an embodiment of the present invention.

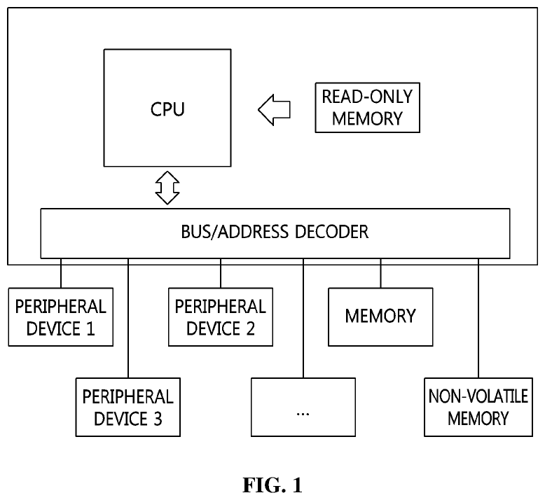

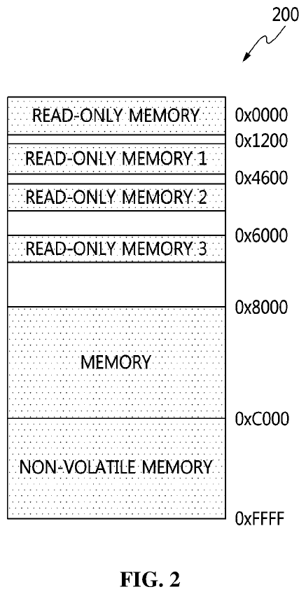

### DESCRIPTION OF THE PREFERRED EMBODIMENTS

The present invention will be described in detail below with reference to the accompanying drawings. Repeated descriptions and descriptions of known functions and configurations which have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Hereinafter, a preferred embodiment of the present invention will be described in detail with reference to the accompanying drawings.

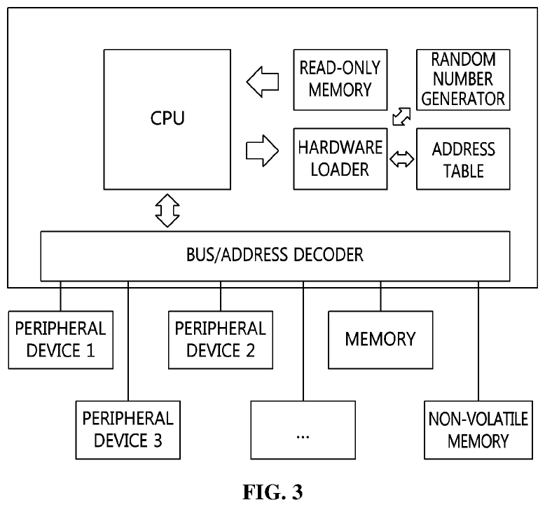

FIG. 3 is a view that shows an embedded system according to an embodiment of the present invention.

Referring to FIG. 3, the embedded system according to an embodiment of the present invention is implemented such that a bus/address decoder, which functions to decode an address, accesses a peripheral device or memory with reference to an address table, which may be dynamically updated.

To this end, the present invention may randomly arrange the respective address regions of peripheral devices and memory using a random number based on a hardware loader, which operates in conjunction with a CPU and a bus/address decoder, each time a program is loaded. Accordingly, the embedded system according to an embodiment of the present invention may include a separate random number generator, as shown in FIG. 3.

Here, the randomly arranged address regions may be arranged in the system address space of the embedded system.

Here, the system address space is defined as memory in which address regions having a certain size are allocated to respective peripheral devices and memory in order to enable software to easily access each device using a simple memory operation without the need to use a special command.

Generally, complicated desktop systems, which support memory virtualization, apply software-based address space layout randomization (ASLR), thereby protecting the system from attacks. However, most embedded systems, which do not support memory virtualization, rarely employ such a protection mechanism. The present invention proposes an ASLR method applicable in an embedded system. Particularly, the present invention proposes a method for randomizing a system address space layout using a hardware device, rather than based on software, each time a program is loaded.

Here, information about the address region that is randomly arranged using a hardware loader may be stored in an address table along with a random start address, which is the start address of the address region.

Then, the hardware loader may reengineer program code for accessing any of peripheral devices or memory with reference to the address table when the program is loaded into the memory.

Accordingly, when the CPU of the embedded system encounters access code for accessing a peripheral device during the execution of the program, which is loaded into the memory, the bus/address decoder refers to the random start address stored in the address table, thereby enabling the CPU to access the corresponding peripheral device or memory.

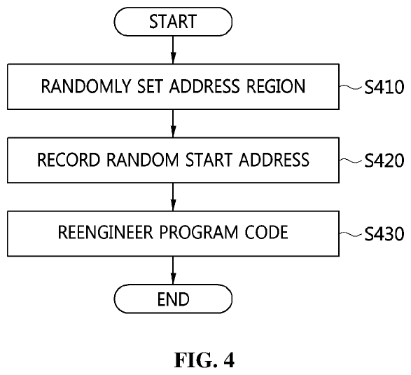

FIG. 4 is a flowchart that shows a method for randomizing the address space layout of an embedded system according to an embodiment of the present invention.

Referring to FIG. 4, in the method for randomizing the address space layout of an embedded system according to an embodiment of the present invention, the hardware loader of the embedded system randomly arranges the respective address regions of multiple peripheral devices and memory based on a random number each time a program is loaded at step S410.

Here, the hardware loader may be initialized based on information stored in read-only memory when the embedded system is reset by applying power thereto.

Here, code and hardware information, which are necessary to operate hardware devices, may be stored in the read-only memory of the embedded system.

For example, code for initializing hardware devices, the initialization of which is required in order to operate the embedded system normally, may be stored at the start of the read-only memory. Accordingly, the hardware loader may be invoked through the hardware initialization process based on the read-only memory.

The invoked hardware loader may map an Interrupt Service Routine (ISR) region based on the memory to the location on the address table in which a start address of the read-only memory of the embedded system is recorded.

Here, the interrupt service routine stored in the ISR region may be a routine for jumping to the start address of a program based on the randomly arranged address regions of memory when an interrupt occurs in the embedded system.

Here, the ISR region may be mapped to the start location of the read-only memory in order to reengineer the ISR. That is, because the ISR cannot be modified in the read-only memory, even though the address region of memory is changed each time a program is loaded in the present invention, the changed address region may not be reflected in the ISR. Accordingly, it is impossible to jump to the start address of the program.

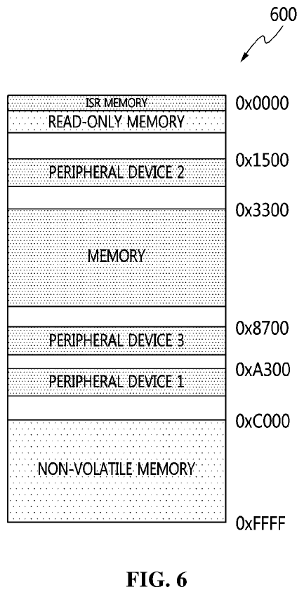

In order to solve this problem, the present invention allocates a portion of writable memory as an ISR region at the start location of the read-only memory, as in the system address space shown in FIG. 6. Accordingly, when execution of the current program is terminated and a new program is loaded, it is possible to jump to the start address of the new program based on the invocation of the ISR.

Here, because the ISR region is located at the fixed position, that is, before the read-only memory in the system address space, an attacker may attempt to read the start address of a program in order to find the memory address, or may attempt to update the ISR region in order to execute desired code.

Accordingly, the present invention grants permissions to access the ISR region only to the hardware loader. Therefore, the address decoder is prevented from writing to or reading from the ISR region in a software manner, whereby the security may be improved.

Here, after it stores the ISR in the ISR region, the hardware loader may obtain a random number that is generated in a hardware manner by accessing a random number generator.

Here, the random number may be used in a calculation process for randomly arranging the address regions of multiple peripheral devices and memory.

For example, different combinations of the address regions of multiple peripheral devices and memory are previously stored in a table, and one of the combinations stored in the table may be selected using the random number.

In another example, different combinations of the address regions of the multiple peripheral devices and memory are generated using an algorithm implemented in a hardware manner in the hardware loader, and one of them may be selected using the random number.

Here, when a new program is loaded after execution of the current program is terminated, the address regions may be randomly updated using a newly generated random number.

Here, the address regions may be randomly arranged with reference to the hardware information stored in the read-only memory of the embedded system, and the hardware information may include the number of multiple peripheral devices and memory and the sizes of the respective address regions thereof.

For example, the hardware loader may check the number of address regions to be randomly arranged and the sizes thereof with reference to the read-only memory, and may then randomly arrange the address regions in consideration of the system address space of the embedded system, as shown in FIG. 6.

Here, because the ISR region must be mapped to the start location of the read-only memory, the hardware information is located after the ISR region, whereby the hardware loader may be operated normally.

Also, in the method for randomizing the address space layout of an embedded system according to an embodiment of the present invention, a random start address of each of the multiple peripheral devices and memory is recorded in an address table at step S420 based on the randomly arranged address regions.

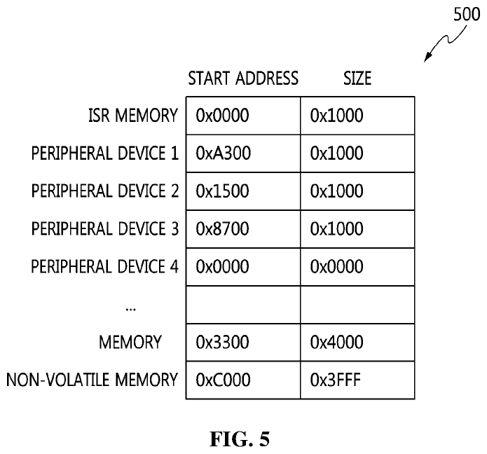

Here, referring to FIG. 5, the address table 500 may include the random start address of each of the multiple peripheral devices and memory along with information about the size of the address region thereof. Such an address table may be referred to when the address decoder of the embedded system checks an input address or accesses any of the multiple peripheral devices and memory.

Here, when the address table 500 is generated as shown in FIG. 5, the system address space of the embedded system may be represented as shown in FIG. 6.

Here, when the address regions of the multiple peripheral devices and memory are randomly updated because a new program is loaded after execution of the current program is terminated, the address table may also be updated so as to match the randomly updated address regions.

Here, the address table may be updated by referring to the hardware information stored in the read-only memory.

Also, in the method for randomizing the address space layout of an embedded system according to an embodiment of the present invention, the hardware loader reengineers the program code loaded into the memory using the address table at step S430 so as to match the randomly arranged address regions.

For example, after the random start addresses are recorded in the address table, the hardware loader may read the program code of the target program to be run by accessing nonvolatile memory. Here, the hardware loader analyzes the read program code, thereby checking whether or not the program code is access code for accessing any of the multiple peripheral devices.

Here, when the program code is access code for accessing any one of the multiple peripheral devices, the start address of the peripheral device to be accessed included in the access code may be changed to the random start address of the peripheral device recorded in the address table.

Here, the entire program code, in which the start address of the peripheral device to be accessed is changed to the random start address thereof, is updated in the memory, whereby the program may be updated.

When reengineering of the entire program code is completed as described above, the hardware loader may invoke an ISR to move to the entry point of the program code loaded into the memory by causing an interrupt.

Here, a command for jumping to the finally mapped start address of the program code, that is, the memory space in which the program code is updated, may be executed through the invoked ISR, whereby the program may be run.

Here, when execution of the program is terminated or when it is necessary to load another program, the hardware loader is invoked again. Here, mapping the ISR region is skipped and the process may be started from the step of generating a random number.

Here, in order to enable the hardware loader according to an embodiment of the present invention to easily change the access code for accessing a peripheral device or memory in the program code, there are some conditions to be applied when program code is written.

First, program code may be position-independent code because the start address at which a program is loaded in the memory can be dynamically changed. For example, program may be written as position-independent code, or may be compiled to position-independent code. In this case, because the program is run regardless of the address at which the program code is loaded, the program may be run without any problem even when the address region of the memory is dynamically changed.

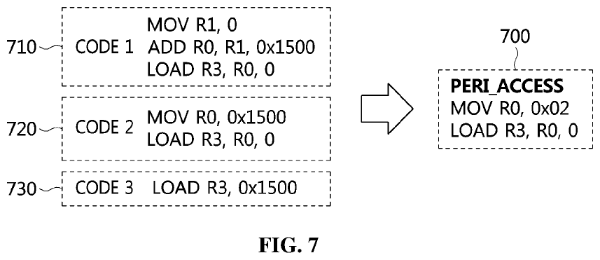

Also, access code for accessing a peripheral device or memory may be unified so as to have a single pattern. For example, all of the three patterns of access code 710, 720 and 730 shown in FIG. 7 may be program code for accessing the peripheral device located at the address ‘0x1500’. However, if the access code has different patterns as shown in FIG. 7, the hardware loader should be implemented such that it is able to find all possible patterns of access code, which may considerably increase the complexity of the design of the hardware loader.

Accordingly, the present invention may unify the different patterns 710, 720 and 730 of access code into the unified pattern of access code 700, as shown in FIG. 7.

Here, when the pattern of access code is unified, the immediate value, which used to indicate the address of the peripheral device to which access is attempted, is made indicate the peripheral device number in the system, whereby the hardware loader may detect the peripheral device to which access is attempted by the access code.

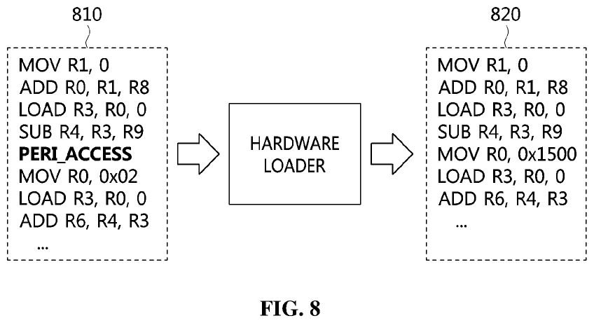

Alternatively, an optional command, PERI_ACCESS, which uses any opcode that is not currently used in the Instruction Set Architecture (ISA) of a CPU, may be inserted immediately before the access code for accessing a peripheral device such that the hardware loader is able to detect the access code, as shown in the nonvolatile memory 810 in FIG. 8.

This additional command may merely serve to tell the hardware loader that the next command is a command for accessing a peripheral device when the hardware loader analyzes each command in the code. Accordingly, the additional command is deleted when the hardware loader updates the command in the memory 820, as shown in FIG. 8. Accordingly, the additional command may not be present in the program code loaded into the memory 820.

Here, the hardware loader reads the immediate value in the command fetched immediately after the PERI_ACCESS command and uses the same as the index of the address table, thereby taking the actual address of the peripheral device and updating the immediate value in the command using the actual address.

Here, after the program code is reengineered, when access code is input during the execution of a program, the address decoder may access the target peripheral device with reference to the random start address included in the access code.

Through the above-described process, even when the address region of memory is changed, after an interrupt service, such as software reset, is performed, a program may be run by moving to the start address of the program loaded to the changed address region of the memory.

The above-described method for randomizing the address space layout of an embedded system makes it difficult for an attacker to detect the location of code or the addresses of main peripheral devices in the memory, which are necessary to attack the embedded system, whereby the security of the system may be improved.

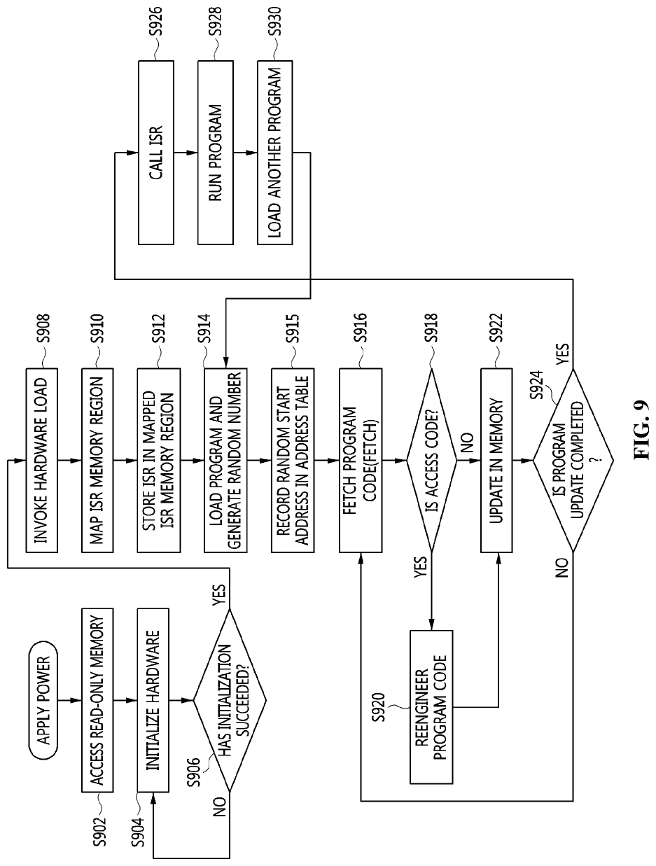

FIG. 9 is a flowchart that specifically shows a method for randomizing the address space layout of an embedded system according to an embodiment of the present invention.

Referring to FIG. 9, in the method for randomizing the address space layout of an embedded system according to an embodiment of the present invention, first, when power is applied to the embedded system, read-only memory is accessed at step S902, and the hardware devices, the initialization of which is required in order to operate the embedded system normally, may be initialized at step S904 based on the information stored in the read-only memory.

Then, whether initialization of the hardware devices succeeds is determined, and when it is determined that the initialization has succeeded, a hardware loader may be invoked at step S908.

Then, the invoked hardware loader may map an Interrupt Service Routine (ISR) region based on memory to the location on the address table in which a start address of the read-only memory of the embedded system is recorded at step S910 and store an interrupt service routine in the ISR region at step S912.

Then, the hardware loader may load a program from nonvolatile memory and generate a random number using a random number generator in response to loading of the program at step S914.

Then, the hardware loader may randomly arrange the respective address regions of multiple peripheral devices and memory using the random number and record the random start addresses thereof, which are the start addresses of the randomly arranged address regions, in an address table at step S915.

Then, the hardware loader may fetch a program code snippet from the memory at step S916, determine whether the program code snippet is access code at step S918, reengineer the program code snippet at step S920 when the program code snippet is determined to be access code, and write the reengineered code snippet to the memory at step S922.

Also, when it is determined at step S918 that the program code snippet is not access code, the program code snippet may be written to the memory without change at step S922.

Then, whether the update of the entire program code of the program is completed is determined at step S924, and when it is determined that the update is not completed, the next code snippet is fetched and step S918 may be performed.

Also, when it is determined at step S924 that the update of the entire program code is completed, the hardware loader invokes the interrupt service routine at step S926, thereby running the program.

Then, when another program is loaded at step S930, the above processes may be repeatedly performed from step S914.

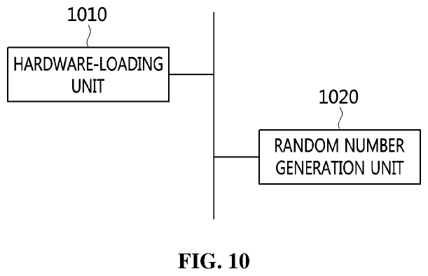

FIG. 10 is a block diagram that shows an apparatus for randomizing an address space layout according to an embodiment of the present invention.

Referring to FIG. 10, the apparatus for randomizing an address space layout according to an embodiment of the present invention includes a hardware-loading unit 1010 and a random number generation unit 1020

The hardware-loading unit 1010 randomly arranges the respective address regions of multiple peripheral devices and memory based on a random number each time the embedded system loads a program.

Here, the apparatus for randomizing an address space layout may be initialized based on information stored in read-only memory when the embedded system is reset by applying power thereto.

Here, code and hardware information, which are necessary to operate hardware devices, may be stored in the read-only memory of the embedded system.

For example, code for initializing hardware devices, the initialization of which is required in order to operate the embedded system normally, may be stored at the start of the read-only memory. Accordingly, the apparatus for randomizing an address space layout may be invoked through the hardware initialization process based on the read-only memory.

First, the invoked apparatus for randomizing an address space layout may map an Interrupt Service Routine (ISR) region based on the memory to the location on the address table in which a start address of the read-only memory of the embedded system is recorded.

Here, the ISR stored in the ISR region may be a routine for jumping to the start address of a program based on the randomly arranged address regions of memory when an interrupt occurs in the embedded system.

Here, the ISR region based on the memory may be mapped to the start location of the read-only memory in order to reengineer the ISR. That is, because the ISR cannot be modified in the read-only memory, even though the address region of memory is changed each time a program is loaded in the present invention, the changed address region may not be reflected in the ISR. Accordingly, it is impossible to jump to the start address of the program.

In order to solve this problem, the present invention allocates a portion of writable memory as an ISR region at the start location of the read-only memory, as in the system address space shown in FIG. 6. Accordingly, when execution of the current program is terminated and a new program is loaded, it is possible to jump to the start address of the new program based on the invocation of the ISR.

Here, because the ISR region is located at the fixed position, that is, before the read-only memory in the system address space, an attacker may attempt to read the start address of a program in order to find the memory address, or may attempt to update the ISR region in order to execute desired code.

Accordingly, the present invention grants permissions to access the ISR region only to the apparatus for randomizing an address space layout. Therefore, the address decoder is prevented from writing to or reading from the ISR region in a software manner, whereby the security may be improved.

Here, after it stores the ISR in the ISR region, and the hardware-loading unit 1010 may obtain a random number that is generated in a hardware manner by accessing the random number generation unit 1020.

Here, the random number may be used in a calculation process for randomly arranging the respective address regions of multiple peripheral devices and memory.

For example, different combinations of the address regions of the multiple peripheral devices and memory are previously stored in a table, and one of the combinations stored in the table may be selected using the random number.

In another example, different combinations of the address regions of the multiple peripheral devices and memory are generated using an algorithm implemented in a hardware manner in the apparatus for randomizing an address space layout, and one of them may be selected using the random number.

Here, when a new program is loaded after execution of the current program is terminated, the address regions may be randomly updated using a newly generated random number.

Here, the address regions may be randomly arranged with reference to the hardware information stored in the read-only memory of the embedded system, and the hardware information may include the number of multiple peripheral devices and memory and the sizes of the respective address regions thereof.

For example, the hardware-loading unit 1010 may check the number of address regions to be randomly arranged and the sizes of the respective address regions with reference to the read-only memory, and may then randomly arrange the address regions in consideration of the system address space of the embedded system, as shown in FIG. 6.

Here, because the ISR region should be mapped before the read-only memory, the hardware information is located after the ISR region, whereby the hardware-loading unit 1010 may be operated normally.

Also, the hardware-loading unit 1010 records a random start address of each of the multiple peripheral devices and memory, which is the start address of the randomly arranged address region, in an address table.

Here, referring to FIG. 5, the address table 500 may include the random start address of each of the multiple peripheral devices and memory along with information about the size of the address region thereof. Such an address table may be referred to when the address decoder of the embedded system checks an input address or accesses any of the multiple peripheral devices and memory.

Here, when the address table 500 is generated as shown in FIG. 5, the system address space of the embedded system may be represented as shown in FIG. 6.

Here, when the address regions of the multiple peripheral devices and memory are randomly updated because a new program is loaded after execution of the current program is terminated, the address table may also be updated so as to match the randomly updated address regions.

Here, the address table may be updated by referring to the hardware information stored in the read-only memory.

Also, the hardware-loading unit 1010 reengineers the program code loaded into the memory using the address table so as to match the randomly arranged address regions.

For example, after the random start addresses are recorded in the address table, the hardware-loading unit 1010 may read each program code snippet of the target program to be run by accessing nonvolatile memory. Here, the hardware-loading unit 1010 analyzes the read program code snippet, thereby checking whether or not the program code snippet is access code for accessing any of the multiple peripheral devices.

Here, when the program code snippet is access code for accessing any one of the multiple peripheral devices, the start address of the peripheral device to be accessed included in the access code may be changed to the random start address of the peripheral device recorded in the address table.

Here, the entire program code, in which the start address of the peripheral device to be accessed is changed to the random start address thereof, is written to the memory, whereby the program may be updated.

When reengineering of the entire program code is completed as described above, the hardware-loading unit 1010 may invoke an ISR to move to the entry point of the program code loaded into the memory by causing an interrupt.

Here, a command for jumping to the finally mapped start address of the program code, that is, the memory space in which the program code is updated, may be executed through the invoked ISR, whereby the program may be run.

Here, when the execution of the program is terminated or when it is necessary to load another program, the apparatus for randomizing an address space layout is invoked again. Here, mapping the ISR region is skipped and the process may be started from the step of generating a random number.

Here, in order to enable the apparatus for randomizing an address space layout according to an embodiment of the present invention to easily change the access code for accessing a peripheral device or memory in the program code when a program is loaded, there are some condition to be applied when program code is written.

First, program code may be position-independent code because the start address at which a program is loaded in the memory can be dynamically changed. For example, a program may be written as or compiled to position-independent code. In this case, because the program is run regardless of the address at which the program code is loaded, the program may be run without any problem even when the address region of the memory is dynamically changed.

Also, access code for accessing a peripheral device or memory may be unified so as to have a single pattern. For example, all of the three patterns of access code 710, 720 and 730 shown in FIG. 7 may be program code for accessing the peripheral device located at the address ‘0x1500’. However, if the access code has different patterns as shown in FIG. 7, it is necessary to implement the apparatus for randomizing an address space layout such that it is able to find all possible patterns of access code, which may considerably increase the complexity of the design of the apparatus for randomizing an address space layout.

Accordingly, the present invention may unify the different patterns 710, 720 and 730 of access code into the unified pattern of access code 700, as shown in FIG. 7.

Here, when the pattern of access code is unified, the immediate value, which used to store the address of the peripheral device to which access is attempted, is made indicate the peripheral device number in the system, whereby the apparatus for randomizing an address space layout may detect the peripheral device to which access is attempted by the access code.

Alternatively, an optional command, PERI_ACCESS, which uses any opcode that is not currently used in the Instruction Set Architecture (ISA) of a CPU, may be inserted immediately before the access code for accessing a peripheral device such that the apparatus for randomizing an address space layout is able to detect the access code, as shown in the nonvolatile memory 810 in FIG. 8.

This additional command may merely serve to tell the apparatus for randomizing an address space layout that the next command is a command for accessing a peripheral device when the apparatus analyzes each command in the code. Accordingly, the additional command is deleted when the hardware-loading unit updates the command in the memory 820, as shown in FIG. 8, and thus the additional command may not be present in the program code loaded into the memory 820.

Here, the apparatus for randomizing an address space layout reads the immediate value in the command fetched after the PERI_ACCESS command and uses the same as the index of the address table, thereby taking the actual address of the peripheral device and updating the immediate value in the command using the actual address.

Here, after the program code is reengineered, when access code is input during the execution of a program, the address decoder may access the target peripheral device using the random start address included in the access code.

Through the above-described process, even when the address region of memory is changed, after an interrupt service, such as software reset, is performed, a program may be run by correctly moving to the start address of the program loaded to the changed address region of memory.

Meanwhile, the apparatus for randomizing an address space layout may include memory installed therein, thereby storing information in the apparatus. In an embodiment, the memory is a computer-readable recording medium. In an embodiment, the memory may be a volatile memory unit, and in another embodiment, the memory may be a nonvolatile memory unit. In an embodiment, the storage device is a computer-readable recording medium. In different embodiments, the storage device may include, for example, a hard-disk device, an optical disk device, or any other kind of mass storage.

The use of the apparatus for randomizing an address space layout makes it difficult for an attacker to predict the location of code or the addresses of peripheral devices in memory, which are required when the attacker attacks an embedded system, thereby improving the security of the system.

According to the present invention, the address space layout of a system may be randomly updated each time a program is loaded, whereby the security of an embedded system may be improved.

Also, the present invention may improve the security of a system by making it difficult for an attacker to guess the location of code or the addresses of main peripheral devices in memory, which are necessary to attack an embedded system.

Also, the present invention changes the addresses of peripheral devices, which are important for security, each time a program is run. Accordingly, even when an attacker detects the location of memory and finds a vulnerability through which the attacker can write to a certain address region, a direct attack on the peripheral device may be prevented.

Also, the present invention may improve the security of an embedded system, which lacks security mechanisms, by merely updating a bus/address decoder, rather than changing a CPU, which is difficult to implement and change in the system.

As described above, the method and apparatus for randomizing the address space layout of an embedded system according to the present invention are not limitedly applied to the configurations and operations of the above-described embodiments, but all or some of the embodiments may be selectively combined and configured, so that the embodiments may be modified in various ways.

What is claimed is:

1. A method for randomizing an address space layout of an embedded system, comprising:
randomly arranging, by a hardware loader of the embedded system, respective address regions of multiple peripheral devices and memory based on a random number each time a program is loaded;
recording, by the hardware loader, respective random start addresses of the multiple peripheral devices and the memory, which are set based on the randomly arranged address regions, in an address table; and
reengineering, by the hardware loader, program code loaded into the memory using the address table so as to match the randomly arranged address regions.

2. The method of claim 1, wherein:
randomly arranging the respective address regions is configured to randomly update the address regions based on a newly generated random number when execution of a current program is terminated and another program is loaded, and
the address table is updated so as to match the randomly updated address regions.

3. The method of claim 1, wherein reengineering the program code is configured such that, when the program code is access code for accessing any one target peripheral device, among the multiple peripheral devices, a start address of the target peripheral device included in the access code is changed to the random start address of the target peripheral device recorded in the address table.

4. The method of claim 1, further comprising:
mapping, by the hardware loader, an Interrupt Service Routine (ISR) region to a location on the address table in which a start address of read-only memory of the embedded system is recorded; and
causing, by the hardware loader, an interrupt and thereby calling an ISR for jumping to a start location of the program code loaded into the memory when reengineering of the program code is completed.

5. The method of claim 4, wherein permissions to access the ISR region are granted only to the hardware loader.

6. The method of claim 1, wherein:
randomly arranging the respective address regions is configured to randomly arrange the address regions with reference to hardware information stored in read-only memory of the embedded system, and
the hardware information includes a number of the multiple peripheral devices and the memory and sizes of the respective address regions of the multiple peripheral devices and the memory.

7. The method of claim 3, wherein the program code is position-independent code, and the access code is unified so as to have a single pattern.

8. The method of claim 3, wherein, when the access code is input based on execution of a program after reengineering of the program code is completed, an address decoder of the embedded system accesses the target peripheral device with reference to the random start address included in the access code.

9. An apparatus for randomizing an address space layout, comprising:
a hardware-loading unit for randomly arranging respective address regions of multiple peripheral devices and memory based on a random number each time a program is loaded in an embedded system, recording respective random start addresses of the multiple peripheral devices and the memory, which are set based on the randomly arranged address regions, in an address table, and reengineering program code loaded into the memory using the address table so as to match the randomly arranged address regions; and
a random number generation unit for generating the random number each time the program is loaded.

10. The apparatus of claim 9, wherein:
when execution of a current program is terminated and another program is loaded, the hardware-loading unit randomly updates the address regions based on a newly generated random number and updates the address table so as to match the randomly updated address regions.

11. The apparatus of claim 9, wherein, when the program code is access code for accessing any one target peripheral device, among the multiple peripheral devices, the hardware-loading unit changes a start address of the target peripheral device included in the access code to the random start address of the target peripheral device recorded in the address table.

12. The apparatus of claim 9, wherein the hardware-loading unit maps an Interrupt Service Routine (ISR) region based on the memory to a location on the address table in which a start address of read-only memory of the embedded system is recorded and causes an interrupt so as to call an ISR for jumping to a start location of the program code loaded into the memory when reengineering of the program code is completed.

13. The apparatus of claim 12, wherein permissions to access the ISR region are granted only to the hardware-loading unit.

14. The apparatus of claim 9, wherein:
the hardware-loading unit randomly arranges the address regions with reference to hardware information stored in read-only memory of the embedded system, and
the hardware information includes a number of the multiple peripheral devices and the memory and sizes of the respective address regions of the multiple peripheral devices and the memory.

15. The apparatus of claim 11, wherein the program code is position-independent code, and the access code is unified so as to have a single pattern.

16. The apparatus of claim 11, wherein, when the access code is input based on execution of a program after reengineering of the program code is completed, an address decoder of the embedded system accesses the target peripheral device with reference to the random start address included in the access code.
